(19) United States
(12) Patent Application Publication
(10) Pub. No.: US 2025/0365110 A1
(43) Pub. Date: Nov. 27, 2025

(54) AGGREGATED WARLESS COMMUNICATION METHOD, DEVICE, AND COMPUTER-READABLE STORAGE MEDIUM

(71) Applicant: ZTE Corporation, Shenzhen (CN)

(72) Inventors: Wei GOU, Shenzhen (CN); Xianghui HAN, Shenzhen (CN); Shuaihua KOU, Shenzhen (CN); Jing SHI, Shenzhen (CN)

(73) Assignee: ZTE Corporation, Shenzhen (CN)

(21) Appl. No.: 19/292,379

(22) Filed: Aug. 6, 2025

Related U.S. Application Data
(63) Continuation of application No. PCT/CN2023/082261, filed on Mar. 17, 2023.

(51) Int. Cl. H04L 5/00; H04B 7/06; H04L 1/00; H04W 72/115; H04W 72/1268

(52) U.S. Cl. CPC H04L 5/0048; H04B 7/0626; H04L 1/0003; H04W 72/115; H04W 72/1268

(57) ABSTRACT

Wireless communication methods are disclosed. A wireless communication method includes obtaining, by a second user equipment (UE), a transmission configuration corresponding to a first user equipment for transmitting the data from the first UE; and transmitting, by the second UE, the data to a base station (BS) according to the transmission configuration.

### TECHNICAL FIELD

This disclosure is generally related to wireless communication, and more particularly wireless communication regarding an aggregated wireless communication.

### BACKGROUND

Wireless communication technologies are pivotal components of the increasingly interconnecting global communication networks. Wireless communications rely on accurately allocated time and frequency resources for transmitting and receiving wireless signals. Coverage and power consumption of the communication device has been an issue in the art, and therefore, different approaches to increase the coverage or accessibility of the communication device or to lower the power consumption may be developed.

### SUMMARY

This summary is a brief description of certain aspects of this disclosure. It is not intended to limit the scope of this disclosure.

According to some embodiments of this disclosure, a wireless communication method is provided. The method includes obtaining, by a second user equipment (UE), a transmission configuration corresponding to a first user equipment for transmitting the data from the first UE; and transmitting, by the second UE, the data to a base station (BS) according to the transmission configuration.

According to some embodiments of this disclosure, a wireless communication method is provided. The method includes receiving, by a base station (BS), first user equipment (UE)'s data transmitted by a second UE according to a transmission configuration.

Still another embodiment of this disclosure provides a wireless communication apparatus, including a memory storing one or more programs and a processor electrically coupled to the memory and configured to execute the one or more programs to perform any method or step or their combination in this disclosure.

Still another embodiment of this disclosure provides non-transitory computer-readable storage medium, storing one or more programs, the one or more program being configured to, when performed by a processor, cause to perform any method or step or their combination in this disclosure.

According to some embodiments of this disclosure, one or more wireless communication methods are further disclosed, the methods include combinations of certain methods, aspects, elements, and steps (either in a generic view or specific view) disclosed in the various embodiments of this disclosure.

The above and other aspects and their implementations are described in greater detail in the drawings, the descriptions, and the claims.

### BRIEF DESCRIPTION OF THE DRAWINGS

Various exemplary embodiments of the present disclosure are described in detail below with reference to the following drawings. The drawings are provided for purposes of illustration only and merely depict exemplary embodiments of the present disclosure to facilitate the understanding of the present disclosure. Therefore, the drawings should not be considered as limiting of the breadth, scope, or applicability of the present disclosure. It should be noted that for clarity and ease of illustration these drawings are not necessarily drawn to scale.

FIG. 1 shows an exemplary wireless communication system according to embodiments of this disclosure.

### DETAILED DESCRIPTION

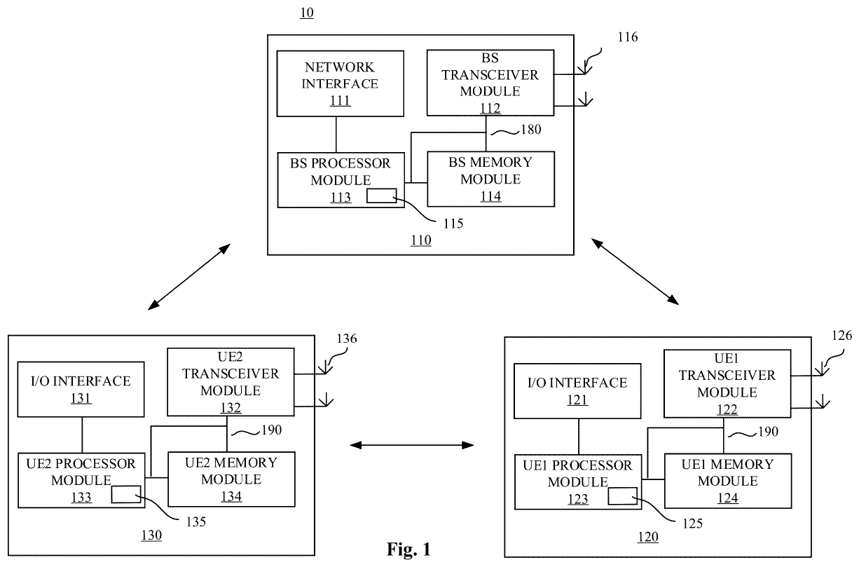

FIG. 1 illustrates a block diagram of an exemplary wireless communication system 10, in accordance with some embodiments of this disclosure. The system 10 may perform the various methods/steps disclosed in this disclosure. The system 10 may include components and elements configured to support operating features that need not be described in detail herein.

The system 10 may include a base station (BS) 110 and first user equipment (UE1) 120. The BS 110 includes a BS transceiver or transceiver module 112, a BS antenna system 116, a BS memory or memory module 114, a BS processor or processor module 113, and a network interface 111. The components of BS 110 may be electrically coupled and in communication with one another as necessary via a data communication bus 180. Likewise, the UE1 120 includes a UE1 transceiver or transceiver module 122, a UE1 antenna system 126, a UE memory or memory module 124, a UE1 processor or processor module 123, and an I/O interface 121. The components of the UE1 120 may be electrically coupled and in communication with one another as necessary via a date communication bus 190. The second user equipment (UE2) 130 includes a UE2 transceiver or transceiver module 132, a UE2 antenna system 136, an UE2 memory or memory module 134, an UE2 processor or processor module 133, and a network interface 131. The components of UE2 130 may be electrically coupled and in communication with one another as necessary via a data communication bus 190. The BS 110 communicates with the UE1 120 and UE2 130 via communication channels therebetween, which can be any wireless channel or other medium known in the art suitable for transmission of data as described herein. In addition, UE1 and UE2 can also communicate with each other via communication channels therebetween, which can be any wireless channel or other medium known in the art suitable for transmission of data as described herein.

As would be understood by persons of ordinary skill in the art, the system 10 may further include any number of modules other than the modules shown in FIG. 1. Those having ordinary skill in the art will understand that the various illustrative blocks, modules, circuits, and processing logic described in connection with the embodiments disclosed herein may be implemented in hardware, computer-readable software, firmware, or any practical combination thereof. To clearly illustrate this interchangeability and compatibility of hardware, firmware, and software, various illustrative components, blocks, modules, circuits, and steps are described generally in terms of their functionality. Whether such functionality is implemented as hardware, firmware, or software depends upon the particular application and design constraints imposed on the overall system. Those familiar with the concepts described herein may implement such functionality in a suitable manner for each particular application, but such implementation decisions should not be interpreted as limiting the scope of the present disclosure.

The processor modules 113, 123, 133 may be implemented, or realized, with a general-purpose processor, a content addressable memory, a digital signal processor, an application specific integrated circuit, a field programmable gate array, any suitable programmable logic device, discrete gate or transistor logic, discrete hardware components, or any combination thereof, designed to perform the functions described herein. In this manner, a processor module may be realized as a microprocessor, a controller, a microcontroller, a state machine, or the like. A processor module may also be implemented as a combination of computing devices, e.g., a combination of a digital signal processor and a microprocessor, a plurality of microprocessors, one or more microprocessors in conjunction with a digital signal processor core, or any other such configuration.

Furthermore, the steps of a method or algorithm described in connection with the embodiments disclosed herein may be embodied directly in hardware, in firmware, in a software module performed by processor modules 113, 123, 133, respectively, or in any practical combination thereof. The memory modules 113, 123, 133 may be realized as RAM memory, flash memory, EEPROM memory, registers, ROM memory, EPROM memory, a hard disk, a removable disk, a CD-ROM, or any other form of storage medium known in the art. In this regard, the memory modules 114, 124, 134 may be coupled to the processor modules 113, 123, 133, respectively, such that the processors modules 113, 123, 133 can read information from, and write information to, memory modules 114, 124, 134, respectively. The memory modules 114, 124, 134 may also be integrated into their respective processor modules 113, 123, 133. In some embodiments, the memory modules 114, 124, 134 may each include a cache memory for storing temporary variables or other intermediate information during execution of instructions to be performed by processor modules 113, 123, 133, respectively. The memory modules 114, 124, 134 may also each include non-volatile memory for storing instructions to be performed by the processor modules 113, 123, 133, respectively.

According to some embodiments of this disclosure, two pieces of user equipment, UE1 and UE2, can be paired to implement UE aggregation transmission. UE1 may receive the UL (uplink) transmission grant in the resources corresponding to the PDCCH (Physical Downlink Control Channel) configuration information of UE1. UE1 may notify UE2 to send UE1's data, including UCI (uplink control information), to the base station (BS). In this example, UE1 or UE2 do not need to report the pairing information to the BS. The BS also does not know that UE1 and UE2 are paired for UE aggregation transmission.

In this example, it can be assumed that UE1 and UE2 are paired for UL (uplink) aggregation transmission. UE2 is configured to transmit data from UE to the BS, and the data interaction between UE1 and UE2 is timely.

### Aggregated Transmission with Minimum System Modification

According to some embodiments of this disclosure, another wireless communication method is disclosed, which includes receiving, by a base station (BS), first user equipment (UE)'s data transmitted by a second UE according to a transmission configuration.

### Dynamical Scheduling of PUSCH by UL Transmission Grant

According to some embodiments, UE1 may receive a UL transmission grant from, and the UL transmission grant schedules a PUSCH (Physical Uplink Shared Channel) to transmit the data of UE1. UE1 may send the to-be-transmitted data to UE2 according to the UL transmission grant. UE1 may also send the time-frequency resource information configured for the PUSCH in the UL transmission grant to UE2. Optionally, UE1 can also send the UL transmission grant to UE2. Then, UE2 may send the to-be-transmitted data from UE1 according to the UL transmission grant information. The UL transmission grant, such as DCI (downlink control information), is generally used to schedule a PUSCH and can be transmitted in a Physical Downlink Control Channel (PDCCH) in the resource corresponding to the PDCCH configuration information.

Alternatively or additionally, UE1 may only send the information necessary for the PUSCH transmission in the UL transmission grant. For example, the information that can be sent from UE1 to UE2 includes resource information, beam information, layer number information and power control related information. The resource information includes at least one of: PRB information, symbol information, time slot information, and carrier information carrying the PUSCH. According to some examples, the carrier used by UE1 to send the data to UE2 can be the same or different carrier from that used by UE2 to send the PUSCH.

Then, UE2 may receive the data and the UL transmission grant from UE1. UE2 can thereby transmit the data (from UE1) based on the relevant parameters in the UL transmission grant. UE2 can may also receive the transmission parameters from UE1, not necessarily the whole transmission grant. UE2 may understand that the relevant parameters in the UL transmission grant are based on the relevant configuration set of UE1. For example, the parameters of the power control used by UE2 to transmit the UE1's data can be determined based on the power control configuration set of UE1. The beam used by UE2 to transmit the UE1's data can also be determined by the beam configuration of the UE1, such as the beam used by UE1 to transmit the data. Therefore, UE2 may replace UE1 to transmit the data without being discerned by the BS. That is, UE1's data can be transmitted only based on UE2's power supply. In this case, the BS still see that UE1 is performing the data transmission.

In some examples as described above, UE2 understands that the relevant parameters in the UL transmission grant are based on the configured parameter set of UE1. For example, the BS may configure the corresponding power control value set for UE1 and indicate an index value in UL transmission grant to select a specific power control value from the set of power control values. However, UE2 may be also configured with another set of power control values. When UE1 sends the index value in UL transmission grant to UE2, the UE2 may use the index value received from UE1 to select or determine a power control value from the set of power control values of UE1 to send data from the UE1. In this case, the set of power control values configured by UE1 may be sent by UE1 to UE2. Alternatively or additionally, UE1 can directly send the final parameter value calculated based on UE1's configuration parameter set to UE2. With respect the to the power control values, UE1 may send the information of the determined specific power control value to UE2.

Optionally in some examples, UE1 may also continue to transmit the data (which has been provided to the UE2) in the PUSCH according to the UL transmission grant, while the UE2 also transmits the UE1's data to the BS. Thereby, UE1 and UE2 may simultaneously transmit the data in the same time-frequency resource in the PUSCH, which is conducive to improve the reliability of data transmission. The BS may use both data from UE1 and UE2 to obtain a better transmission quality.

Optional in some examples, two copies of data can be scheduled by a UL transmission grant for UE1 in two PUSCHs, and UE1 may determine one data and sends it to UE2. UE2 can transmit the received data to the BS according to the above description.

The BS receives the data in the PUSCH according to the UL transmission grant. According to some examples, whether the data is transmitted by UE1 or UE2, the BS may understand that the data belongs to UE1. the Since the BS does not need to know whether the data is actually sent by UE1, the existing BS can be reused without significant modification. In these examples, because UE2 transmits the data based on the UL transmission grant of UE1, the BS may understands that the data are transmitted by UE1 in the PUSCH.

### Semi-Static Transmission

According to some examples, UE1 can send the scheduling request (SR) configuration information of UE1 to UE2. If UE1 needs to send a SR for uplink data, then UE1 may notify the relevant information of the SR to UE2. UE2 may transmit an SR PUCCH (Physical Uplink Control Channel) based on the SR configuration information of UE1, which is provided by UE1. For example, after UE2 is notified by UE1 for transmitting an SR on the PUCCH, UE2 may generate an SR sequence based on the SR configuration information of UE1 and determine an SR PUCCH resource based on the SR configuration information of UE1. UE2 then transmits an SR PUCCH based on the determined SR sequence and the SR PUCCH resource. The BS receives the SR PUCCH based on the SR configuration information of UE1, and the BS sees it is the uplink data of UE1 to be scheduled for transmission based on the SR.

Alternatively or additionally, UE1 can also send the SR PUCCH based on the SR configuration information of UE1, so UE1 and UE2 send the same SR sequence in the same SR PUCCH resource, thereby improving the coverage and performance of the SR PUCCH.

According to some examples, UE1 may send UE1's CSI (Channel Status Information) PUCCH configuration information to UE2. If UE1 needs to send a CSI reporting, then UE1 may provide the relevant information of the CSI reporting to UE2. UE2 may transmit a CSI PUCCH based on the CSI PUCCH configuration information of UE1, which is provided by UE1. For example, after UE2 is notified by UE1 for transmitting a CSI PUCCH, UE2 may generate a CSI report configuration based on the CSI PUCCH configuration information of UE1, determine a CSI PUCCH resource based on the CSI PUCCH configuration information from UE1, and transmit a CSI PUCCH based on the determined CSI report configuration and the CSI PUCCH resource. The BS receives the CSI PUCCH based on the CSI PUCCH configuration information of UE1, and the BS sees that the CSI PUCCH is transmitted from UE1.

Alternatively or additionally, UE1 can also send the CSI PUCCH based on the CSI PUCCH configuration information of UE1, so UE1 and UE2 send the same CSI PUCCH in the same CSI PUCCH resource, thereby improving the coverage and performance of the CSI PUCCH.

According to some examples, UE1 can send UE1's SRS (Sounding Reference Signal) configuration information to UE2. If UE1 needs to send an SRS, then UE1 may notify the relevant information of the SRS to UE2. UE2 may transmit an SRS based on the SRS configuration information of UE1. For example, after UE2 is notified by UE1 for transmitting an SRS, UE2 generates an SRS sequence based on the SRS configuration information of UE1, determines an SRS resource based on the SRS configuration information of UE1, and transmits an SRS based on the determined SRS sequence and the SRS resource. The BS receives the SRS based on the SRS configuration information of UE1, and the BS thinks that the SRS is transmitted from UE1.

Alternatively or additionally, UE1 can also send the SRS based on the SRS configuration information of UE1, so UE1 and UE2 send the same SRS sequence in the same SRS resource, thus improving the coverage and performance of the SRS.

According to some examples, UE1 may send UE1's CG PUSCH (Configured Grant Physical Uplink Shared Channel) configuration information to UE2. If UE1 needs to send data, then UE1 may provide the data to UE2. UE2 may transmit the data based on the CG PUSCH configuration information of UE1. For example, after UE2 is notified by UE1 for transmitting data, UE2 processes the data as the final transmitted data based on the CG PUSCH configuration information of UE1, determines a CG PUSCH resource based on the CG PUSCH configuration information of UE1, and transmits the final data based on the determined the CG PUSCH resource. The BS receives the data based on the CG PUSCH configuration information of UE1, and the BS thinks that the CG PUSCH is transmitted from UE1.

Alternatively or additionally, UE1 can also send the data based on the CG PUSCH configuration information of UE1, so UE1 and UE2 send the same data in the same CG PUSCH resource, thereby improving the coverage and performance of the data.

The examples described above may improve the coverage of UE1 and improve the performance of UE1's transmission. Alternatively or additionally, if the UE1 has a limited power, but not UE2, the approaches are beneficial to extend the UE1 usage time.

According to some embodiments of this disclosure, a wireless communication method disclosed, which includes obtaining, by a second user equipment (UE), a transmission configuration corresponding to a first user equipment for transmitting the data from the first UE; and transmitting, by the second UE, the data to a base station (BS) according to the transmission configuration.

According to some embodiments, the wireless communication method may further include receiving transmission configuration information from the first UE, wherein obtaining the transmission configuration comprises obtaining the transmission configuration based on the transmission configuration information.

According to some embodiments, the transmission configuration information includes at least one of: an uplink (UL) transmission grant, which was received by the first UE from the BS, a resource information, MCS information, beam information, layer number information, or power control information.

According to some embodiments, obtaining the transmission configuration based on the transmission configuration information includes selecting a configuration setting from a set of candidate settings of the second UE based on the transmission configuration information.

According to some embodiments, the wireless communication method may further include receiving, by the second UE from the first UE, at least one of: SR (scheduling request) configuration information of the first UE, CSI (Channel Status Information) PUCCH (Physical Uplink Control Channel) configuration information of the first UE, SRS (Sounding Reference Signal) configuration information of the first UE, or CG PUSCH configuration information of the first UE.

According to some embodiments, the wireless communication method may further include at least one of: determining, by the second UE, at least one of: an SR sequence or an SR PUCCH resource based on the SR configuration information;
transmitting, by the second UE, an SR PUCCH based on the SR configuration information;
determining, by the second UE, at least one of: a CSI reporting or a CSI PUCCH resource based on the CSI PUCCH configuration information;
transmitting, by the second UE, a CSI PUCCH based on the CSI PUCCH configuration information;
determining, by the second UE, at least one of: an SRS sequence or an SRS resource based on the SRS configuration information;
transmitting, by the second UE, an SRS based on the SRS configuration information;
determining, by the second UE, to-be-transmitted data or a CG PUSCH resource based on the CG PUSCH configuration; or
transmitting, by the second UE, the data based on the CG PUSCH configuration.

According to some embodiments, the wireless communication method may further include receiving, by the first UE or the second UE, a UL transmission grant indicating the transmission configuration information configured for the second UE or configured based on the environment of the second UE.

According to some embodiments, the wireless communication method may further include receiving, by the second UE from the BS or the first UE, a UL transmission grant indicating transmission configuration information or the transmission configuration information, configured for the second UE or configured based on the environment of the second UE.

According to some embodiments, the wireless communication method may further include transmitting, by the second UE, the data to the BS includes transmitting, by the second UE, the data at the same time with the first UE.

According to some embodiments, a wireless communication method is disclosed, which includes receiving, by a base station (BS), first user equipment (UE)'s data transmitted by a second UE according to a transmission configuration.

According to some embodiments, the method further includes transmitting transmission configuration information to the first UE or the second UE, the transmission configuration information includes at least one of: an uplink (UL) transmission grant, a resource information, beam information, layer number information, or power control information.

According to some embodiments, the method further includes receiving, from the second UE, an SR PUCCH transmitted based on at least one of an SR sequence or an SR PUCCH resource based on the SR configuration information determined according to SR configuration information;
receiving, from the second UE, a CSI PUCCH transmitted based on at least one of a CSI reporting or a CSI PUCCH resource determined according to CSI PUCCH configuration information;
receiving, from the second UE, an SRS transmitted based on at least one of an SRS sequence or an SRS resource determined according to the SRS configuration information; or
receiving, from the second UE, the data transmitted based on a CG PUSCH resource determined according to the CG PUSCH configuration.

### Aggregation Transmission with Reported Pairing Information

Alternatively or additionally according to some embodiments of this disclosure, UE1 or UE2 may report the pairing information to the BS. The BS is thereby aware that UE1 and UE2 are paired for UE aggregation transmission. Here, UE1 and UE2 can be paired for UE aggregation transmission. UE1 receives the UL transmission grant in the resources corresponding to the PDCCH configuration information of UE1, and UE1 may use UE2 for sending UE1's data (including UCI information) to the BS. It can be assumed that UE1 and UE2 are paired for UL aggregation transmission, that UE2 transmits data from UE1 to the BS, and that the data interaction between UE1 and UE2 is timely.

In some example, a new RRC (Radio Resource Control) signaling can be introduced, which can be used for UE1 or UE2 to notify the BS that UE1 and UE2 are paired for aggregate transmission. Optionally, the RRC signaling be used for UE1 or UE2 to further inform the BS that UE2 is used to transmit data of the UE1.

### Dynamically Scheduling PUSCH by UL Transmission Grant

According to some examples, UE1 receives a UL transmission grant from PDCCH, and the UL transmission grant schedules a PUSCH to transmit UE1's data. UE1 may send the to-be-transmitted data to UE2 according to the UL transmission grant. UE1 may also send time-frequency resource information configured for the PUSCH in the UL transmission grant to UE2. Optionally, UE1 can also send the UL transmission grant to UE2. UE2 may send the data from UE1 according to the UL transmission grant's information. Alternatively or additionally, UE1 may only send the information necessary for the PUSCH transmission in the UL transmission grant. For example, the information includes at least one of resource information (including at least one of PRB information, symbol information, slot information, or carrier information carrying the PUSCH), beam information, layer number information, or power control related information. The carrier used by UE1 to send the data to UE2 can be the same or different from that used by UE2 to send the PUSCH.

According to some examples, UE2 receives the data and the UL transmission grant from UE1, and UE2 transmits the data based on the relevant parameters in the UL transmission grant. Additionally or alternatively, UE2 may only receive the relevant parameters in need for UL transmission. UE2 understands that the relevant parameters in the UL transmission grant are based on the relevant configuration set of UE2. For example, the parameters of power control used by UE2 to transmit the data from UE1 can be determined based on the power control configuration set of UE2. The beam used by UE2 to transmit the data can also be the beam used by UE2 to transmit the data.

According to some examples, the UE2 receives a UL grant from UE1 and transmits the data from the UE1. Here, the UL transmission grant may be configured by the BS and sent to UE1, but the values of the relevant parameters in the UL grant are configured based on the set of the parameter values of UE2, which can improve the transmission efficiency because the values of these related parameters better match the channel environment of the UE2, which is the device that transmits the data. In this case, since the BS understands that the UE2 transmits the data that came from the UE1, the BS can configure, based on the channel environment of UE2, the relevant parameters in the UL transmission grant received by the UE1.

### Configuration of Relevant Parameters of UL Transmission Grant

Since the BS is aware that the UE2 transmits the data of the UE1, the BS may configure some of the relevant parameters in the UL transmission grant based on the channel environment of the UE2. Therefore, UE1 receives a UL transmission grant, but some or all of the relevant parameters in this UL transmission grant are configured for UE2 based on UE2's environment, not for UE1. These parameters may mainly include parameters related to UL transmission, such as at least one of the following: MCS (Modulation and Coding Scheme) information, receiving/transmitting beam information, information of the number of layers, power control parameters, or time-frequency resource information. The BS can configure or agree with UE which parameters in the UL transmission grant are configured for UE1 and which parameters are for UE2. The number of layers may indicate the number of layers used to transmit the data. For example, if two layers is used to transmit the data, two data blocks can be transmitted at the same time. The two layers may use the same time-frequency resources.

Optionally, the BS may configure the same time-frequency resource set (such as TDRA (Time Domain Resource Allocation) table and FDRA (Frequency Domain Resource allocation) table) for UE1 and UE2, so that UE1 and UE2 can obtain the same time-frequency resource from their respective time-frequency resource set based on a time-domain resource allocation indication index and a frequency-domain resource allocation indication index in the UL transmission grant. Optionally, the BS may configure the same MCS set for UE1 and UE2, so that UE1 and UE2 can obtain the same MCS parameters from their respective MCS sets based on an MCS index in the UL transmission grant. In this way, if the UE1 also transmits the same data as the UE2, the same time-frequency resources and MCS can be used together to restore the received data, achieve in an additional gain.

Optionally, in the UL transmission grant, some parameters can be configured with multiple sets respectively, and each set may correspond to a UE in the paired group. For example, for the paired UE1 and UE2, the configuration of the parameters in the UL transmission grant may include at least one of the following: two sets of MCS parameters, two sets of layer parameters, two sets of power control parameters, two sets of TDRA parameters, two sets of FDRA parameters, two sets of beam information, etc. Each set can be configured for either UE1 or UE2. For example, the first set of above parameters is for UE1, and the second set of above parameters is for UE2. After UE1 receives the UL transmission grant, UE1 may send the second set of parameters to UE2. UE1 may send the first data to the BS based on the first set of parameters. UE2 may send the second data to the BS based on the second set of parameters. It is noted that the second data send by UE2 is from UE1.

Alternatively or additionally, UE1 may send the second data to UE2, and UE2 sends the second data to the BS based on the second set of parameters. The UE may also send the first data to the BS based on the first set of parameters.

Alternatively or additionally, it can also be determined whether the first data and the second data are the same according to the signaling indication from the BS. The signaling indication can be configured in the UL transmission grant or RRC signaling.

Alternatively or additionally, UE1 can also optionally continue to transmit the data in the PUSCH according to the UL transmission grant. In this way, UE1 and UE2 simultaneously transmit the data in the same time-frequency resource in the PUSCH, which is conducive to improve the reliability of transmission.

Alternatively or additionally, two copies of data are optionally scheduled by a UL transmission grant for UE1 in two PUSCHs, and UE1 may determine one copy of the data and send the determined copy to UE2. Then, UE2 can transmit the received copy to the BS according to the above approaches.

Correspondingly, the BS may receive the data in the PUSCH from the UE1 and/or UE2 according to the relevant parameters in the UL transmission grant. For example, the BS receives data of the UE1 from the UE2, and the data is transmitted based on beam information of the UE2. When UE2 transmits the data instead of UE1, the relevant parameters corresponding to the channel environment of UE2 (such as MCS and beam information) can be used as much as possible to ensure the transmission performance.

### Semi-Static Transmission

In a case that UE1 and/or UE2 reports to the BS that UE1 and UE2 are paired for aggregate transmission and that UE2 transmits the data from UE1, the BS knows that UE1 and UE2 are paired.

Additionally or alternatively, the BS may provide UE1's the SR (Scheduling Request) configuration information to UE2. For example, a UE ID can be introduced into the existing SR configuration information, and the UE ID indicates a UE associated with the SR configuration information. The UE ID can be used in the paired UEs to obtain a smaller signaling overhead. For example, if two UEs are paired for UE aggregation transmission, the UE ID can be 1 bit, and the different values of the 1 bit correspond to one of the two paired UEs. Alternatively or additionally, if UE1 or UE2 reports the pairing information to the BS and UE2 sends the data of UE1, the BS can configure an SR configuration information for UE2. UE2 considers that the SR configuration information is for UE1 paired with UE2.

In some examples, if UE1 needs to send a scheduling request (SR) for uplink data, then UE1 may provide the relevant information of the SR to UE2. UE2 transmits an SR PUCCH based on the SR configuration information of UE1. For example, after UE2 is notified by UE1 to transmit an SR PUCCH, UE2 generates an SR sequence based on the SR configuration information of UE1, determines an SR PUCCH resource based on the SR configuration information of UE1, and transmits an SR PUCCH based on the determined SR sequence and the SR PUCCH resource. The BS receives the SR PUCCH based on the SR configuration information of UE1, and the BS sees that it is the the uplink data of UE1 that needs to be scheduled.

Alternatively or additionally, UE1 can also send the SR PUCCH based on the SR configuration information of UE1, so UE1 and UE2 can send the same SR sequence in the same SR PUCCH resource, thus improving the coverage and performance of the SR PUCCH.

In some examples, the BS can provide the CSI PUCCH configuration information of UE1 to UE2. A UE ID can be introduced into the existing CSI PUCCH configuration information. The UE ID indicates a UE associated with the CSI PUCCH configuration information. The UE ID can be used in the paired UEs to obtain a smaller signaling overhead. For example, if two UEs are paired for UE aggregation transmission, the UE ID can be 1 bit, and the different values of the 1 bit correspond to one of the two paired UEs. Alternatively or additionally, if UE1 or UE2 reports the pairing information to the BS and UE2 sends the data of UE1, the BS configures an CSI PUCCH configuration information for UE2. UE2 may consider that the CSI PUCCH configuration information is for UE1 paired with UE2.

In some examples, if UE1 needs to send a CSI reporting, UE1 provides the relevant information of the CSI reporting to UE2. UE2 may transmit a CSI PUCCH based on the CSI PUCCH configuration information of UE1. For example, after UE2 is notified by UE1 to transmit a CSI PUCCH, UE2 generates a CSI reporting based on the CSI PUCCH configuration information of UE1, determines a CSI PUCCH resource based on the CSI PUCCH configuration information of UE1, and transmits a CSI PUCCH based on the determined CSI reporting and the CSI PUCCH resource. The BS receives the CSI PUCCH based on the CSI PUCCH configuration information of UE1, and the BS thinks that the CSI PUCCH is transmitted from UE1.

Alternatively or additionally, UE1 can also send the CSI PUCCH based on the CSI PUCCH configuration information of UE1, so UE1 and UE2 send the same CSI PUCCH in the same CSI PUCCH resource, thus improving the coverage and performance of the CSI PUCCH.

In some examples, the BS provides the SRS configuration information of UE1 to UE2. Alternatively or additionally, a UE ID can be introduced into the existing SRS configuration information, and the UE ID indicates a UE associated with the SRS configuration information. The UE ID can be designed in the paired UEs to obtain a smaller signaling overhead. For example, if two UEs are paired for UE aggregation transmission, the UE ID can be 1 bit, and the different values of the 1 bit correspond to one of the two paired UEs. Alternatively or additionally, if UE1 or UE2 reports the pairing information to the BS and UE2 sends the data of UE1, the BS configures an SRS configuration information for UE2. UE2 considers that the SRS configuration information is for UE1 paired with UE2.

In some examples, if UE1 needs to send an SRS, UE1 provides the relevant information of the SRS to UE2. UE2 transmits an SRS based on the SRS configuration information of UE1. For example, after UE2 is notified by UE1 to transmit an SRS, UE2 generates an SRS sequence based on the SRS configuration information of UE1, determines an SRS resource based on the SRS configuration information of UE1, and transmits an SRS based on the determined SRS sequence and the SRS resource. The BS receives the SRS based on the SRS configuration information of UE1, and the BS thinks that the SRS is transmitted from UE1.

Alternatively or additionally, UE1 can also send the SRS based on the SRS configuration information of UE1, so UE1 and UE2 send the same SRS sequence in the same SRS resource, thus improving the coverage and performance of the SRS.

In some example, the BS provides the CG PUSCH configuration information of UE1 to UE2. Alternatively or additionally, a UE ID can be introduced into the existing CG PUSCH configuration information. The UE ID indicates a UE associated with the CG PUSCH configuration information. The UE ID can be designed in the paired UEs to obtain a smaller signaling overhead. For example, if two UEs are paired for UE aggregation transmission, the UE ID can be 1 bit, and the different values of the 1 bit correspond to one of the two paired UEs. Alternatively or additionally, if UE1 or UE2 reports the pairing information to the BS and UE2 sends the data of UE1, the BS configures an CG PUSCH configuration information for UE2. UE2 considers that the CG PUSCH configuration information is for UE1 paired with UE2.

In some examples, if UE1 needs to send data, UE1 provides the data to UE2. UE2 transmits the data based on the CG PUSCH configuration information of UE1. For example, after UE2 is notified by UE1 to transmit data, UE2 processes the data as the final transmitted data based on the CG PUSCH configuration information of UE1, determines a CG PUSCH resource based on the CG PUSCH configuration information of UE1, and transmits the final data based on the determined the CG PUSCH resource. The BS receives the data based on the CG PUSCH configuration information of UE1, and the BS thinks that the CG PUSCH is transmitted from UE1.

Alternatively or additionally, UE1 can also send the data based on the CG PUSCH configuration information of UE1, so UE1 and UE2 send the same data in the same CG PUSCH resource, thus improving the coverage and performance of the data.

The above approaches can improve the coverage of UE1 and improve the performance of UE1 transmission.

According to some embodiments of this disclosure, a wireless communication method disclosed, which includes obtaining, by a second user equipment (UE), a transmission configuration corresponding to a first user equipment for transmitting the data from the first UE; and transmitting, by the second UE, the data to a base station (BS) according to the transmission configuration.

According to some embodiments, the wireless communication method may further include transmitting an signaling (such as an RRC signaling) to the BS to indicate that the first UE and the second UE are paired for aggregated transmission.

According to some embodiments, the wireless communication method may further include receiving, by the first UE, a UL transmission grant indicating transmission configuration information, which includes two sets of transmission configurations, respectively configured for the first UE and the second UE.

According to some embodiments, the wireless communication method may further include receiving, by the second UE from the first UE, at least one of: SR configuration information of the first UE, CSI PUCCH configuration information of the first UE, SRS configuration information of the first UE, or CG PUSCH configuration information of the first UE.

According to some embodiments, the wireless communication method may further include receiving, by the second UE from the BS, at least one of: SR (scheduling request) configuration information of the first UE or the second UE, CSI PUCCH configuration information of the first UE or the second UE, SRS configuration information of the first UE or the second UE, or CG PUSCH configuration information of the first UE or the second UE.

According to some embodiments, at least one of the SR configuration information, CSI PUCCH configuration information, SRS configuration information, or CG PUSCH configuration information includes a UE ID, which indicates whether the at least one configuration information is associated to the first UE or the second UE.

According to some embodiments, the wireless communication method may further include determining, by the second UE, at least one of: an SR sequence or an SR PUCCH resource based on the SR configuration information;
transmitting, by the second UE, an SR PUCCH based on the SR configuration information;
determining, by the second UE, at least one of: a CSI reporting or a CSI PUCCH resource based on the CSI PUCCH configuration information;
transmitting, by the second UE, a CSI PUCCH based on the CSI PUCCH configuration information;
determining, by the second UE, at least one of: an SRS sequence or an SRS resource based on the SRS configuration information;
transmitting, by the second UE, an SRS based on the SRS configuration information;
determining, by the second UE, to-be-transmitted data or a CG PUSCH resource based on the CG PUSCH configuration; or
transmitting, by the second UE, the data based on the CG PUSCH configuration.

According to some embodiments of this disclosure, a wireless communication method is disclosed, which includes receiving, by a base station (BS), first user equipment (UE)'s data transmitted by a second UE according to a transmission configuration.

According to some embodiments of this disclosure, the method may further include receiving a signaling (such as an RRC signaling), by the BS, indicating that the first UE and the second UE are paired for aggregated transmission.

According to some embodiments of this disclosure, the method may further include transmitting, by the BS to the first UE, a UL transmission grant indicating transmission configuration information, which includes two sets of transmission configurations, respectively configured for the first UE and the second UE.

According to some embodiments of this disclosure, the method may further include transmitting, by the BS to the first UE or the second UE, at least one of: SR (scheduling request) configuration information of the first UE or the second UE, CSI PUCCH configuration information of the first UE or the second UE, SRS configuration information of the first UE or the second UE, or CG PUSCH configuration information of the first UE or the second UE.

According to some embodiments of this disclosure, at least one of the SR configuration information of the first UE or the second UE, CSI PUCCH configuration information of the first UE or the second UE, SRS configuration information of the first UE or the second UE, or CG PUSCH configuration information of the first UE or the second UE includes a UE ID, which indicates whether the at least one configuration information is associated to the first UE or the second UE.

According to some embodiments of this disclosure, the method may further include at least one of:
receiving, from the second UE, an SR PUCCH based on at least one of an SR sequence or an SR PUCCH resource based on the SR configuration information determined according to SR configuration information;
receiving, from the second UE, a CSI PUCCH based on at least one of a CSI reporting or a CSI PUCCH resource determined according to CSI PUCCH configuration information;
determining, by the second UE, at least one of: an SRS sequence or an SRS resource based on the SRS configuration information;
receiving, from the second UE, an SRS based on at least one of an SRS sequence or an SRS resource determined according to the SRS configuration information; or receiving, from the second UE, the data based on a CG PUSCH resource determined according to the CG PUSCH configuration.

### UL Transmission Grant for UE2

According to some embodiments of this disclosure, UE1 and UE2 are paired for UE aggregation transmission, and UE2 can send data received from UE1 (including uplink control information (UCI)) to the BS. UE2 can receive a UL transmission grant (or DCI) for UE1; for example, the UL transmission grant can be sent by the BS to UE2. UE1 or UE2 can report the pairing information to the BS, so the BS knows that UE1 and UE2 are paired for UE aggregation transmission. The UL transmission grant, such as DCI (downlink control information), is generally used to schedule a PUSCH and can be transmitted in a PDCCH (Physical Downlink Control Channel) in the resource corresponding to the PDCCH configuration information.

According to some embodiments in this disclosure, the BS or UE1 can provide the UL transmission grant associated with the transmission of the data of UE1 to UE2. The BS can also provide the UL transmission grant associated with the transmission of the data of UE2 to UE2. At least one of the C-RNTI associated with UE1 or transmission of UE1 data, C-RNTI associate with UE2 or transmission of UE2 data, PDCCH configuration information associated with UE1 or transmission of UE1, or PDCCH configuration information associated with UE2 or transmission of UE2, or the PDCCH resource used to transmit the UL transmission grant can be used to determine whether a UL transmission grant is configured for the transmission of the data from UE1 or data originated at UE2. Further, the C-RNTI or PDCCH configuration information can be configured either by the UE or the BS.

### UE-Configured C-RNTI and PDCCH Configuration Information

In some examples, UE1 or UE2 can report the pairing information to the BS, so the BS knows that UE1 and UE2 are paired for UE aggregation transmission. UE1 and UE2 are paired for UE aggregation transmission, and UE2 can send data received from UE1 (including uplink control information (UCI)) to the BS.

In these examples, UE1 notifies the C-RNTI (Cell-Radio Network Temporary Identifier) of the UE1 and PDCCH configuration information of the UE1 to the UE2. UE2 can detect the UL transmission grant for the UE1 based on the C-RNTI of the UE1 in the resources corresponding to the PDCCH configuration information of the UE1.

The BS can transmit a UL transmission grant scrambled with the C-RNTI of the UE1 in the resource corresponding to the PDCCH configuration information of the UE1, but the parameters (such as at least one of MCS, time-frequency resource configuration, beam information, power control information, or a number of layers) in the UL transmission grant can be configured for the UE2 and/or based on UE2's environment. The data corresponding to the UL transmission grant is the data of the UE1, and UE2 is configured to transmit the data to the BS. The UL transmission grant of the UE1 can be received by the UE2 from the BS.

In these examples, UE2 detects the UL transmission grant based on the C-RNTI of UE1 in the resources corresponding to the PDCCH configuration information of the UE1. After the UE2 detects the UL transmission grant scrambled with the C-RNTI of the UE1, the UE2 requests the to-be-transmitted data corresponding to the UL transmission grant from the UE1. UE1 sends the corresponding data to UE2, and UE2 transmits the data based on the UL transmission grant to the BS. For example, UE2 determines the value of the relevant parameters for transmitting the data from the corresponding configuration set of the UE2 based on the parameters in the UL transmission grant.

Additionally or alternatively, UE1 can also detect the UL transmission grant based on the C-RNTI of UE1 in the resources corresponding to the PDCCH configuration information of the UE1. UE1 can also transmit the data based on the UL transmission grant, such that both UE1 and UE2 send the data to the BS.

### UE-Configured C-RNTI and BS-Configured PDCCH Configuration Information

In some examples, UE1 or UE2 can report the pairing information to the BS, so the BS knows that UE1 and UE2 are paired for UE aggregation transmission. UE1 and UE2 are paired for UE aggregation transmission, and UE2 can send data received from UE1 (including uplink control information (UCI)) to the BS. The BS receives the reported pairing information from UE1 or UE2. The BS knows that UE1 and UE2 are paired for UE aggregation transmission, and UE2 sends data from UE1 to the BS.

In these examples, UE1 notifies the C-RNTI (but not necessarily the PDCCH configuration information) of the UE1 to the UE2. UE2 can detect the UL transmission grant for the UE1 based on the C-RNTI of the UE1 in the resources corresponding to the PDCCH configuration information of the UE1. On the other hand, the BS configures/notifies the PDCCH configuration information of the UE1 to the UE2. The BS can transmit a UL transmission grant scrambled with the C-RNTI of the UE1 in the resource corresponding to the PDCCH configuration information of the UE1, but the parameters in the UL transmission grant (such as at least one of MCS, time-frequency resource configuration, beam information, power control information, or a number of layers) are configured for the UE2 (not for UE1). The data corresponding to the UL transmission grant is the data of the UE1.

In these examples, the BS configures the PDCCH configuration information of UE1 to UE2. Additionally or alternatively, the BS configures a PDCCH configuration information for UE2, and the configured PDCCH configuration information (or the resources corresponding to the configured PDCCH configuration information) is the same or different from the PDCCH configuration information of UE1 (or the resources corresponding to the PDCCH configuration information of UE1). UE2 detects a UL transmission grant based on the configured C-RNTI in the resources corresponding to the configured PDCCH configuration information.

From the perspective of UE2, UE2 considers that the configured PDCCH configuration information is used to receive the UL transmission grant corresponding to UE1 to perform UE aggregation transmission. The configured PDCCH configuration information (or the resources corresponding to the configured PDCCH configuration information) can be the same or different from the PDCCH configuration information of UE2 (or the resources corresponding to the PDCCH configuration information of UE2).

Alternatively or additionally, BS can configure a PDCCH configuration information for UE2 (optionally marked with index 0 for the PDCCH configuration information and optionally marked the corresponding PDCCH resource as PDCCH resource 0 for the PDCCH resource). In the PDCCH resource 0, the BS may send the UL transmission grant scrambled by UE2's C-RNTI, UE2 may receive the UL transmission grant from the PDCCH resource 0 based on UE2's C-RNTI. According to some examples, to support UE aggregation transmission, an improvement can be introduced. New PDCCH configuration information and/or PDCCH resource can be introduced. UE can use which PDCCH resource/configuration information is used to transmit the UL transmission grant to tell whether the UL transmission grant is associated with transmission of the data of UE1 or data of UE2. For example, if the pairing information of UE1 and UE2 is received by the BS from UE1 or UE2, the BS may configure an extra PDCCH configuration information for UE2 (optionally marked as index 1 for the PDCCH configuration information and optionally marked the corresponding PDCCH resource as PDCCH resource 1). In the PDCCH resource 1, the BS can send a UL transmission grant scrambled by UE2's C-RNTI, UE2 may receive the UL grant based on UE2's C-RNTI in the PDCCH resource 1. UE2 understands that the UL grant in the PDCCH resource 1 is used by UE2 to transmit data from UE1. UE2 may understand that the UL grant in the PDCCH resource 0 is used by UE2 to transmit data from UE2. Under this mechanism, UE2 can receive a UL transmission grant associated with UE1 based on UE2's C-RNTI instead of UE1's C-RNTI. UE2 can tell whether a UL transmission grant is for the transmission of the UE1 data by UE2 or for the transmission of UE2's own data according to whether the UL transmission grant is received from the PDCCH resource 0 or PDCCH resource 1. UE2 does not need to have the C-RNTI of UE1 for the UL transmission grant, therefore, the security of the system is improved. Here, PDCCH configuration information 1 and PDCCH configuration information 0 can be the same or different, and PDCCH resource 1 and PDCCH resource 0 can be the same or different. If they are the same, the UL transmission grant in PDCCH resource 0 and the UL transmission grant in PUCCH resource 1 can be sent from different base stations (or other network nodes similar to base stations, such as relay stations). Here, because the UE2 can use the UL transmission grant's source to tell whether the UL transmission grant is configured for the transmission of UE1's data by UE2 or for the transmission of UE2's own data.

Additionally, if the PDCCH configuration information 1 is not configured for UE2, the BS and UE2 can agree that the PDCCH resource 0 is used for UE2 to receive a UL grant based on UE2's C-RNTI, but the UL transmission grant is used for UE2 to transmit data from UE1. PDCCH resource 0 can be used when UE2 does not need to transmit data from UE2. Alternatively, if the PDCCH configuration information 1 is not configured for UE2, the BS and UE2 can agree that the PDCCH resource 0 is used for UE2 to receive a UL transmission grant based on UE2's C-RNTI, but the UL grant is only used for UE2 to transmit data from UE2. It can be used when the BS does not want to support aggregate transmission of UE1 and UE2.

The UE2 detects the UL transmission grant based on the C-RNTI of UE1 in the resources corresponding to the PDCCH configuration information of the UE1. After UE2 detects the UL transmission grant scrambled with the C-RNTI of the UE1, the UE2 requests the to-be-transmitted data corresponding to the UL transmission grant from the UE1. Then, UE1 sends the corresponding data to UE2, and UE2 transmits the data based on the UL transmission grant. For example, UE2 determines the value of the relevant parameters for transmitting the data from the corresponding configuration set of the UE2 based on the parameters in the UL transmission grant.

Alternatively or additionally, the UE1 can also detect the UL transmission grant based on the C-RNTI of UE1 in the resources corresponding to the PDCCH configuration information of the UE1. The UE1 can also transmit the data based on the UL transmission grant. That is, both UE1 and UE2 send the data to the BS.

### UE-Configured C-RNTI

In some examples, UE1 or UE2 can report the pairing information to the BS, so the BS knows that UE1 and UE2 are paired for UE aggregation transmission. UE1 and UE2 are paired for UE aggregation transmission, and UE2 can send data received from UE1 (including uplink control information (UCI)) to the BS.

Additionally or alternatively, UE1 notifies the C-RNTI (but not necessarily the PDCCH configuration information) of the UE1 to the UE2. UE2 can detect the UL transmission grant for the UE1 based on the C-RNTI of UE1 in the resources corresponding to the PDCCH configuration information of UE2.

In these examples, the BS may not configure the PDCCH configuration information of the UE1 to the UE2. The BS can transmit a UL transmission grant scrambled with the C-RNTI of the UE1 in the resource corresponding to the PDCCH configuration information of the UE2, and the parameters in the UL transmission grant (such as at least one of MCS, time-frequency resource configuration, beam information, power control information, a number of layers, etc.) are configured for the UE2. The data corresponding to the UL transmission grant is the data of the UE1.

Additionally or alternatively, the BS can also, optionally, send a UL transmission grant scrambled by C-RNTI of UE1 in the resource corresponding to the PDCCH configuration information of UE1, and the UL transmission grant also schedules a data transmission. The data scheduled by the UL transmission grant can be the same or different from the UE1's data transmitted by UE2, and the UL transmission grant can be the same or different from the UE1's UL transmission grant sent in the resource corresponding to the PDCCH configuration information of UE2.

Additionally or alternatively, UE2 can detect the UL transmission grant based on the C-RNTI of UE1 in the resources corresponding to the PDCCH configuration information of the UE2. After the UE2 detects the UL transmission grant scrambled with the C-RNTI of the UE1, the UE2 requests the to-be-transmitted data corresponding to the UL transmission grant from the UE1. UE1 sends the corresponding data to UE2, and the UE2 transmits the data based on the UL transmission grant. For example, the UE2 determines the value of the relevant parameters for transmitting the data from the corresponding configuration set of the UE2 based on the parameters in the UL transmission grant.

Additionally or alternatively, the UE1 can also detect the UL transmission grant based on the C-RNTI of UE1 in the resources corresponding to the PDCCH configuration information of the UE1. The UE1 can also transmit the data based on the UL transmission grant. That is, both UE1 and UE2 send the data to the BS. The data scheduled by the UL transmission grant is the same or different from the UE1's data transmitted by UE2, and the UL transmission grant is the same or different from the UE's UL transmission grant sent in the resource corresponding to the PDCCH configuration information of UE2.

### UE-Configured PDCCH Configuration Information and BS-Configured C-RNTI

In some examples, UE1 and UE2 are paired for UE aggregation transmission, and UE2 can send data from UE1 (also including uplink control information (UCI)) to the BS. UE1 or UE2 reports the pairing information to the BS, so BS knows that UE1 and UE2 are paired for UE aggregation transmission, and UE2 sends data from UE1 to the BS.

In these examples, UE1 notifies the PDCCH configuration information of the UE1 to the UE2. UE2 can detect the UL transmission grant for the UE1 based on the C-RNTI of the UE1 in the resources corresponding to the PDCCH configuration information of the UE1.

The BS configures the C-RNTI of the UE1 to the UE2. The BS can transmit a UL transmission grant scrambled with the C-RNTI of the UE in the resource corresponding to the PDCCH configuration information of the UE1, but the parameters in the UL transmission grant (such as MCS, time-frequency resource configuration, beam information, power control information, number of layers, etc.) are configured for the UE2. The data corresponding to the UL transmission grant is required to be the data of the UE1.

The BS configures the C-RNTI of UE1 to UE2. Additionally or alternatively, the BS configures a C-RNTI for UE2. The configured C-RNTI is the same or different from the C-RNTI of UE1, and UE2 detects a UL transmission grant based on the configured C-RNTI in the resource corresponding to the PDCCH configuration information of UE1. The other processes are the same as above. From the perspective of UE2, UE2 considers that the configured C-RNTI is used to receive a UL transmission grant corresponding to UE1, which is paired with UE2 to perform UE aggregation transmission.

UE2 detects the UL transmission grant based on the C-RNTI of UE1 in the resources corresponding to the PDCCH configuration information of the UE1. After the UE2 detects the UL transmission grant scrambled with the C-RNTI of the UE1, UE2 requests the to-be-transmitted data corresponding to the UL transmission grant from the UE1. UE1 sends the corresponding data to UE2, and the UE2 then transmits the data based on the UL transmission grant. For example, the UE2 determines the value of the relevant parameters for transmitting the data from the corresponding configuration set of the UE2 based on the parameters in the UL transmission grant.

Additionally or alternatively, UE1 can also detect the UL transmission grant based on the C-RNTI of UE1 in the resources corresponding to the PDCCH configuration information of the UE1. UE1 can also transmit the data based on the UL transmission grant. That is, both UE1 and UE2 send the data to the BS.

BS-Configured C-RNTI and PDCCH configuration information

In some examples, UE1 and UE2 are paired for UE aggregation transmission, and UE2 can send data from UE1 (also including uplink control information (UCI)) to the BS. UE1 or UE2 reports the pairing information to the BS. The BS knows that UE1 and UE2 are paired for UE aggregation transmission, and UE2 sends data from UE1 to the BS.

In these examples, UE2 receives the UL transmission grant of UE1 based on the C-RNTI configured by the BS in the resource corresponding to the PDCCH configuration information configured by the BS.

The BS configures the C-RNTI of the UE1 and the PDCCH configuration information of UE1 to the UE2. The BS can transmit a UL transmission grant scrambled with the C-RNTI of the UE1 in the resource corresponding to the PDCCH configuration information of the UE1, but the parameters in the UL transmission grant (such as MCS, time-frequency resource configuration, beam information, power control information, number of layers, etc.) are configured for the UE2. The data corresponding to the UL transmission grant is required to be the data of the UE1.

In these examples, the BS configures the C-RNTI of UE1 to UE2. Alternatively or additionally, BS configures a C-RNTI for UE2, and the configured C-RNTI is the same or different from the C-RNTI of UE1. UE2 detects a UL transmission grant based on the configured C-RNTI in the resource corresponding to the PDCCH configuration information of UE1. The other processes are the same as above. From the perspective of UE2, UE2 considers that the configured C-RNTI is used to receive a UL transmission grant corresponding to UE1, which is paired with UE2 to perform UE aggregation transmission.

In these examples, the BS configures the PDCCH configuration information of UE1 to UE2. Alternatively or additionally, the BS configures a PDCCH configuration information for UE2, and the configured PDCCH configuration information (or the resources corresponding to the configured PDCCH configuration information) is the same or different from the PDCCH configuration information of UE1 (or the resources corresponding to the PDCCH configuration information of UE1). UE2 detects a UL transmission grant based on the configured C-RNTI in the resources corresponding to the configured PDCCH configuration information. From the perspective of UE2, UE2 considers that the configured PDCCH configuration information is used to receive the UL transmission grant corresponding to UE1. The configured PDCCH configuration information (or the resources corresponding to the configured PDCCH configuration information) can be the same or different from the PDCCH configuration information of UE2 (or the resources corresponding to the PDCCH configuration information of UE2).

Alternatively or additionally, BS can configure a PDCCH configuration information for UE2 (optionally marked with index 0 for the PDCCH configuration information and optionally marked the corresponding PDCCH resource as PDCCH resource 0 for the PDCCH resource). In the PDCCH resource 0, the BS may send the UL transmission grant scrambled by UE2's C-RNTI, UE2 may receive the UL transmission grant from the PDCCH resource 0 based on UE2's C-RNTI. According to some examples, to support UE aggregation transmission, an improvement can be introduced. New PDCCH configuration information and/or PDCCH resource can be introduced. UE can use which PDCCH resource/configuration information is used to transmit the UL transmission grant to tell whether the UL transmission grant is associated with transmission of the data of UE1 or data of UE2. For example, if the pairing information of UE1 and UE2 is received by the BS from UE1 or UE2, the BS may configure an extra PDCCH configuration information for UE2 (optionally marked as index 1 for the PDCCH configuration information and optionally marked the corresponding PDCCH resource as PDCCH resource 1). In the PDCCH resource 1, the BS can send a UL transmission grant scrambled by UE2's C-RNTI, UE2 may receive the UL grant based on UE2's C-RNTI in the PDCCH resource 1. UE2 understands that the UL grant in the PDCCH resource 1 is used by UE2 to transmit data from UE1. UE2 may understand that the UL grant in the PDCCH resource 0 is used by UE2 to transmit data from UE2. Under this mechanism, UE2 can receive a UL transmission grant associated with UE1 based on UE2's C-RNTI instead of UE1's C-RNTI. UE2 can tell whether a UL transmission grant is for the transmission of the UE1 data by UE2 or for the transmission of UE2's own data according to whether the UL transmission grant is received from the PDCCH resource 0 or PDCCH resource 1. UE2 does not need to have the C-RNTI of UE1 for the UL transmission grant, therefore, the security of the system is improved. Here, PDCCH configuration information 1 and PDCCH configuration information 0 can be the same or different, and PDCCH resource 1 and PDCCH resource 0 can be the same or different. If they are the same, the UL transmission grant in PDCCH resource 0 and the UL transmission grant in PUCCH resource 1 can be sent from different base stations (or other network nodes similar to base stations, such as relay stations). Here, because the UE2 can use the UL transmission grant's source to tell whether the UL transmission grant is configured for the transmission of UE1's data by UE2 or for the transmission of UE2's own data.

Additionally, if the PDCCH configuration information 1 is not configured for UE2, the BS and UE2 can agree that the PDCCH resource 0 is used for UE2 to receive a UL grant based on UE2's C-RNTI, but the UL transmission grant is used for UE2 to transmit data from UE1. PDCCH resource 0 can be used when UE2 does not need to transmit data from UE2. Alternatively, if the PDCCH configuration information 1 is not configured for UE2, the BS and UE2 can agree that the PDCCH resource 0 is used for UE2 to receive a UL transmission grant based on UE2's C-RNTI, but the UL grant is only used for UE2 to transmit data from UE2. It can be used when the BS does not want to support aggregate transmission of UE1 and UE2.

In the various examples in this disclosure, the BS can transmit a UL transmission grant scrambled with the configured C-RNTI in the resource corresponding to the configured PDCCH configuration information, but the parameters in the UL transmission grant (such as MCS, time-frequency resource configuration, beam information, power control information, number of layers, etc.) are configured for the UE2 (which is used to transmit the data of UE1). The data corresponding to the UL transmission grant is required to be the data of the UE1. UE2 receives the UL transmission grant based on the configured C-RNTI in the resource corresponding to the configured PDCCH configuration information, UE2 may also receives the UL transmission grant based on the C-RNTI of UE2 in the resource corresponding to the PDCCH configuration information of UE2.

Optionally in some examples, the BS can also send a UL transmission grant scrambled by C-RNTI of UE1 in the resource corresponding to the PDCCH configuration information of UE1, and the UL transmission grant also schedules a data transmission. Here, the data scheduled by this UL transmission grant is the same or different from the UE1's data transmitted by UE2, and the UL transmission grant is the same or different from the UE's UL transmission grant sent in the resource corresponding to the PDCCH configuration information of UE2.

In some examples, UE2 detects the UL transmission grant based on the C-RNTI of UE1 in the resources corresponding to the PDCCH configuration information of the UE1. After the UE2 detects the UL transmission grant scrambled with the C-RNTI of UE1, UE2 requests the to-be-transmitted data corresponding to the UL transmission grant from the UE1. UE1 then sends the corresponding data to UE2, and UE2 transmits the data based on the UL transmission grant. For example, UE2 determines the value of the relevant parameters for transmitting the data from the corresponding configuration set of the UE2 based on the parameters in the UL transmission grant.

In some examples, the UE1 can also detect the UL transmission grant based on the C-RNTI of UE1 in the resources corresponding to the PDCCH configuration information of the UE1. The UE1 can also transmit the data based on the UL transmission grant. That is, both UE1 and UE2 send the data to the BS. The data scheduled by the UL transmission grant can be the same or different from the UE1's data transmitted by UE2, and the UL transmission grant is the same or different from the UE's UL transmission grant sent in the resource corresponding to the PDCCH configuration information of UE2.

### BS-Configured C-RNTI

In some examples, UE1 and UE2 are paired for UE aggregation transmission, and UE2 can send data from UE1 (also including uplink control information (UCI)) to the BS. UE1 or UE2 reports the pairing information to the BS. The BS knows that UE1 and UE2 are paired for UE aggregation transmission, and UE2 sends data from UE1 to the BS.

In these examples, the UE2 receives the UL transmission grant of the UE1 based on the C-RNTI configured by the BS in the resource corresponding to the PDCCH configuration information of UE2.

The BS configures the C-RNTI of the UE1 to the UE2. The BS can transmit a UL transmission grant scrambled with the C-RNTI of the UE1 in the resource corresponding to the PDCCH configuration information of the UE2, but the parameters in the UL transmission grant (such as MCS, time-frequency resource configuration, beam information, power control information, number of layers, etc.) are configured for the UE2. The data corresponding to the UL transmission grant is required to be the data of the UE1.

In these examples, the BS configures the C-RNTI of UE1 to UE2. Alternatively or additionally, the BS configures a C-RNTI for UE2, and the configured C-RNTI is the same or different from the C-RNTI of UE1. UE2 can detect a UL transmission grant based on the configured C-RNTI in the resource corresponding to the PDCCH configuration information of UE1. From the perspective of UE2, UE2 considers that the configured C-RNTI is used to receive a UL transmission grant corresponding to UE1 that is paired with UE2 to perform UE aggregation transmission. The configured C-RNTI can be the same or different from the C-RNTI of UE2.

Correspondingly in these examples, the BS can transmit a UL transmission grant scrambled with the configured C-RNTI in the resource corresponding to the PDCCH configuration information of UE2, but the parameters in the UL transmission grant (such as MCS, time-frequency resource configuration, beam information, power control information, number of layers, etc.) are configured for the UE2, and the data corresponding to the UL transmission grant is the data of the UE1. UE2 receives the UL transmission grant based on the configured C-RNTI in the resource corresponding to the PDCCH configuration information of UE2. UE2 also receives the UL transmission grant based on the C-RNTI of UE2 in the resource corresponding to the PDCCH configuration information of UE2.

Optionally, the BS can also send a UL transmission grant scrambled by C-RNTI of UE1 in the resource corresponding to the PDCCH configuration information of UE1, and the UL transmission grant also schedules a data transmission. The data scheduled by the UL transmission grant is the same or different from the UE1's data transmitted by UE2, and the UL transmission grant is the same or different from the UE's UL transmission grant sent in the resource corresponding to the PDCCH configuration information of UE2.

Additionally or alternatively, UE2 detects the UL transmission grant based on the C-RNTI of UE1 in the resources corresponding to the PDCCH configuration information of the UE2. After UE2 detects the UL transmission grant scrambled with the C-RNTI of the UE1, UE2 requests the data corresponding to the UL transmission grant from the UE1. UE1 then sends the corresponding data to UE2, and UE2 transmits the data based on the UL transmission grant. For example, UE2 determines the value of the relevant parameters for transmitting the data from the corresponding configuration set of the UE2 based on the parameters in the UL transmission grant.

Additionally or alternatively, UE1 can also detect the UL transmission grant based on the C-RNTI of UE1 in the resources corresponding to the PDCCH configuration information of the UE1. UE1 can also transmit the data based on the UL transmission grant. That is, both UE1 and UE2 send the data to the BS. The data scheduled by the UL transmission grant is the same or different from the UE1's data transmitted by UE2, and the UL transmission grant is the same or different from the UE's UL transmission grant sent in the resource corresponding to the PDCCH configuration information of UE2.

According to some embodiments of this disclosure, a wireless communication method disclosed, which includes obtaining, by a second user equipment (UE), a transmission configuration corresponding to a first user equipment for transmitting the data from the first UE; and transmitting, by the second UE, the data to a base station (BS) according to the transmission configuration.

According to some embodiments, the method may further include detecting, by the second UE based on at least one of a C-RNTI associated with the first UE, a C-RNTI associated with the second UE, a PDCCH configuration information associated with the first UE, or a PDCCH configuration information associated with the second UE, a UL transmission grant provided by the BS, wherein obtaining the transmission configuration for transmitting the data comprises obtaining transmission configuration from the UL transmission grant.

According to some embodiments, the method may further include receiving, by the second UE from the first UE, the C-RNTI associated with the first UE and the PDCCH configuration information associated with the first UE, wherein the C-RNTI associated with the first UE and the PDCCH configuration information associated with the first UE are notified by the first UE.

According to some embodiments, the method may further include receiving, by the second UE from the BS, the PDCCH configuration information associated with the first UE or the PDCCH configuration information associated with the second UE, wherein the PDCCH configuration information associated with the first UE or the PDCCH configuration information associated with the second UE are configured by the BS; and detecting the UL transmission grant by the second UE comprises detecting the UL transmission grant by the second UE based on the received the PDCCH configuration information associated with the first UE or the PDCCH configuration information associated with the second UE.

According to some embodiments, the UL transmission grant is scrambled by the C-RNTI associated with the first UE or the C-RNTI associated with the second UE.

According to some embodiments, the method may further include receiving, by the second UE, the C-RNTI associated with the first UE from the first UE, wherein: the C-RNTI associated with the first UE is notified by the first UE; and detecting the UL transmission grant by the second UE comprises detecting the UL transmission grant by the second UE based on the C-RNTI associated with the first UE on a PDCCH recourse corresponding to the PDCCH configuration information associated with the second UE.

According to some embodiments, the method may further include receiving, by the second UE, the PDCCH configuration information associated with the first UE from the first UE and receiving the C-RNTI associated with UE 1 from the BS, wherein the PDCCH configuration information associated with the first UE is notified by the first UE; and detecting the UL transmission grant by the second UE comprises detecting the UL transmission grant based on the C-RNTI associated with UE 1 on a PDCCH recourse corresponding to the PDCCH configuration information associated with the first UE.

According to some embodiments, the method may further include receiving, by the second UE, the C-RNTI associated with the first UE from the BS, wherein the C-RNTI associated with the first UE is configured by the BS and detecting the UL transmission grant by the second UE comprises detecting the UL transmission grant according to the C-RNTI associated with the first UE on a PDCCH recourse corresponding to the PDCCH configuration information associated with the second UE.

According to some embodiments, the method may further include determining, according to a PDCCH resource used to deliver the UL transmission grant, whether the UL transmission grant detected based on the C-RNTI associated with the second UE is configured for transmission of data from the first UE or data originated from the UE2.

According to some embodiments, the method may further include receiving, by the first UE or the second UE, a UL transmission grant indicating the transmission configuration information configured for the second UE or configured based on the environment of the second UE.

According to some embodiments, the method may further include comprising receiving, by the second UE from the BS or the first UE, a UL transmission grant indicating transmission configuration information or the transmission configuration information, configured for the second UE or configured based on the environment of the second UE.

According to some embodiments, transmitting, by the second UE, the data to the BS comprises transmitting, by the second UE, the data at the same time with the first UE.

According to some embodiments, a wireless communication method is disclosed, which includes receiving, by a base station (BS), first user equipment (UE)'s data transmitted by a second UE according to a transmission configuration.

According to some embodiments, the method may further include transmitting, by the BS to the first UE or the second UE at least one of a C-RNTI associated with the first UE, a C-RNTI associated with the second UE, a PDCCH configuration information associated with the first UE, or a PDCCH configuration information associated with the second UE; and transmitting, by the BS to the first UE or the second UE, a UL transmission grant on a resource corresponding to the PDCCH configuration information associated with the first UE or the second UE.

According to some embodiments, the UL transmission grant indicates the transmission configuration information configured for the second UE or configured based on the environment of the second UE.

According to some embodiments, the method may further include configuring two sets of PDCCH configuration information corresponding to two PDCCH resources for transmitting UL transmission grants respectively for UL data transmission of the first UE's data or the second UE's data.

According to some embodiments, the method may further include receiving different copies of data from the first UE and the second UE.

Various exemplary embodiments of the present disclosure are described herein with reference to the accompanying figures to enable a person of ordinary skill in the art to make and use the present disclosure. The present disclosure is not limited to the exemplary embodiments and applications described and illustrated herein. Additionally, the specific order and/or hierarchy of steps in the methods disclosed herein are merely exemplary approaches. Based upon design preferences, the specific order or hierarchy of steps of the disclosed methods or processes can be re-arranged while remaining within the scope of the present disclosure. Thus, those of ordinary skill in the art would understand that the methods and techniques disclosed herein present various steps or acts in exemplary order(s), and the present disclosure is not limited to the specific order or hierarchy presented unless expressly stated otherwise.

This disclosure is intended to cover any conceivable variations, uses, combination, or adaptive changes of this disclosure following the general principles of this disclosure, and includes well-known knowledge and conventional technical means in the art and undisclosed in this application.

It is to be understood that this disclosure is not limited to the precise structures or operation described above and shown in the accompanying drawings, and various modifications and changes may be made without departing from the scope of this application. The scope of this application is subject only to the appended claims.

The methods, devices, processing, circuitry, and logic described above may be implemented in many different ways and in many different combinations of hardware and software. For example, all or parts of the implementations may be circuitry that includes an instruction processor or controller, such as a Central Processing Unit (CPU), microcontroller, or a microprocessor; or as an Application Specific Integrated Circuit (ASIC), Programmable Logic Device (PLD), or Field Programmable Gate Array (FPGA); or as circuitry that includes discrete logic or other circuit components, including analog circuit components, digital circuit components or both; or any combination thereof. The circuitry may include discrete interconnected hardware components or may be combined on a single integrated circuit die, distributed among multiple integrated circuit dies, or implemented in a Multiple Chip Module (MCM) of multiple integrated circuit dies in a common package, as examples.

Accordingly, the circuitry may store or access instructions for execution, or may implement its functionality in hardware alone. The instructions may be stored in a tangible storage medium that is other than a transitory signal, such as a flash memory, a Random Access Memory (RAM), a Read Only Memory (ROM), an Erasable Programmable Read Only Memory (EPROM); or on a magnetic or optical disc, such as a Compact Disc Read Only Memory (CDROM), Hard Disk Drive (HDD), or other magnetic or optical disk; or in or on another machine-readable medium. A product, such as a computer program product, may include a storage medium and instructions stored in or on the medium, and the instructions when performed by the circuitry in a device may cause the device to implement any of the processing described above or illustrated in the drawings.

The implementations may be distributed. For instance, the circuitry may include multiple distinct system components, such as multiple processors and memories, and may span multiple distributed processing systems. Parameters, databases, and other data structures may be separately stored and managed, may be incorporated into a single memory or database, may be logically and physically organized in many different ways, and may be implemented in many different ways. Example implementations include linked lists, program variables, hash tables, arrays, records (e.g., database records), objects, and implicit storage mechanisms. Instructions may form parts (e.g., subroutines or other code sections) of a single program, may form multiple separate programs, may be distributed across multiple memories and processors, and may be implemented in many different ways. Example implementations include stand-alone programs, and as part of a library, such as a shared library like a Dynamic Link Library (DLL). The library, for example, may contain shared data and one or more shared programs that include instructions that perform any of the processing described above or illustrated in the drawings, when performed by the circuitry.

In some examples, each unit, subunit, and/or module of the system may include a logical component. Each logical component may be hardware or a combination of hardware and software. For example, each logical component may include an application specific integrated circuit (ASIC), a Field Programmable Gate Array (FPGA), a digital logic circuit, an analog circuit, a combination of discrete circuits, gates, or any other type of hardware or combination thereof. Alternatively or in addition, each logical component may include memory hardware, such as a portion of the memory, for example, that includes instructions executable with the processor or other processors to implement one or more of the features of the logical components. When any one of the logical components includes the portion of the memory that includes instructions executable with the processor, the logical component may or may not include the processor. In some examples, each logical component may just be the portion of the memory or other physical memory that includes instructions executable with the processor or other processor to implement the features of the corresponding logical component without the logical component including any other hardware. Because each logical component includes at least some hardware even when the included hardware includes software, each logical component may be interchangeably referred to as a hardware logical component.

A second action may be said to be “in response to” a first action independent of whether the second action results directly or indirectly from the first action. The second action may occur at a substantially later time than the first action and still be in response to the first action. Similarly, the second action may be said to be in response to the first action even if intervening actions take place between the first action and the second action, and even if one or more of the intervening actions directly cause the second action to be performed. For example, a second action may be in response to a first action if the first action sets a flag and a third action later initiates the second action whenever the flag is set.

To clarify the use of and to hereby provide notice to the public, the phrases “at least one of <A>, <B>, . . . and <N>” or “at least one of <A>, <B>, . . . <N>, or combinations thereof” or “<A>, <B>, . . . and/or <N>” are defined by the Applicant in the broadest sense, superseding any other implied definitions hereinbefore or hereinafter unless expressly asserted by the Applicant to the contrary, to mean one or more elements selected from the group comprising A, B, . . . and N. In other words, the phrases mean any combination of one or more of the elements A, B, . . . or N including any one element alone or the one element in combination with one or more of the other elements which may also include, in combination, additional elements not listed.

1. A wireless communication method, comprising:
obtaining, by second user equipment (UE), a transmission configuration corresponding to first user equipment for transmitting data from the first UE; and
transmitting, by the second UE, the data to a base station (BS) according to the transmission configuration.

2. The method of claim 1, further comprising:
receiving transmission configuration information from the first UE, wherein obtaining the transmission configuration comprises obtaining the transmission configuration based on the transmission configuration information,
wherein;
the transmission configuration information includes at least one of: an uplink (UL) transmission grant, which was received by the first UE from the BS, a resource information. MCS information, beam information, layer number information, or power control information: or
obtaining the transmission configuration based on the transmission configuration information comprises selecting a configuration setting from a set of candidate settings of the second UE based on the transmission configuration information.

3-4. (canceled)

5. The method of claim 1, further comprising:
receiving, by the second UE from the first UE, at least one of: SR (scheduling request) configuration information of the first UE, CSI (Channel Status Information) PUCCH (Physical Uplink Control Channel) configuration information of the first UE, SRS (Sounding Reference Signal) configuration information of the first UE, or CG PUSCH configuration information of the first UE; and
at least one of:
determining, by the second UE, at least one of: an SR sequence or an SR PUCCH resource based on the SR configuration information;
transmitting, by the second UE, an SR PUCCH based on the SR configuration information:
determining, by the second UE. at least one of: a CSI reporting or a CSI PUCCH resource based on the CSI PUCCH configuration information;
transmitting, by the second UE, a CSI PUCCH based on the CSI PUCCH configuration information;
determining, by the second UE, at least one of: an SRS sequence or an SRS resource based on the SRS configuration information;
transmitting, by the second UE, an SRS based on the SRS configuration information;
determining, by the second UE, to-be-transmitted data or a CG PUSCH resource based on the CG PUSCH configuration; or
transmitting, by the second UE, the data based on the CG PUSCH configuration.

6. (canceled)

7. The method of claim 1, further comprising:
transmitting an RRC signaling to the BS to indicate that the first UE and the second UE are paired for aggregated transmission; or
receiving, by the first UE, a UL transmission grant indicating transmission configuration information, which includes two sets of transmission configurations. respectively configured for the first UE and the second UE.

8. (canceled)

9. The method of claim 1, further comprising:
receiving, by the second UE from the first UE, at least one of: scheduling request (SR) configuration information of the first UE, CSI PUCCH configuration information of the first UE, SRS configuration information of the first UE, or CG PUSCH configuration information of the first UE; or
receiving, by the second UE from the BS, at least one of: SR (scheduling request) configuration information of the first UE or the second UE, CSI PUCCH configuration information of the first UE or the second UE, SRS configuration information of the first UE or the second UE, or CG PUSCH configuration information of the first UE or the second UE.

10. (canceled)

11. The method of claims 9, wherein;
at least one of the SR configuration information, CSI PUCCH configuration information, SRS configuration information, or CG PUSCH configuration information includes a UE ID, which indicates whether the at least one configuration information is associated to the first UE or the second UE; or
wherein the method further comprises at least one of:
determining, by the second UE, at least one of: an SR sequence or an SR PUCCH resource based on the SR configuration information;
transmitting, by the second UE, an SR PUCCH based on the SR configuration information;
determining, by the second UE, at least one of: a CSI reporting or a CSI PUCCH resource based on the CSI PUCCH configuration information;
transmitting, by the second UE, a CSI PUCCH based on the CSI PUCCH configuration information;
determining, by the second UE, at least one of: an SRS sequence or an SRS resource based on the SRS configuration information:
transmitting, by the second UE, an SRS based on the SRS configuration information;
determining, by the second UE, to-be-transmitted data or a CG PUSCH resource based on the CG PUSCH configuration; or
transmitting, by the second UE, the data based on the CG PUSCH configuration.

12. (canceled)

13. The method of claim 1, further comprising detecting, by the second UE based on at least one of a C-RNTI associated with the first UE, a C-RNTI associated with the second UE, a PDCCH configuration information associated with the first UE, or a PDCCH configuration information associated with the second UE, a UL transmission grant provided by the BS, wherein obtaining the transmission configuration for transmitting the data comprises obtaining transmission configuration from the UL transmission grant.

14. (canceled)

15. The method of claim 13, further comprising:
receiving, by the second UE from the BS, the PDCCH configuration information associated with the first UE or the PDCCH configuration information associated with the second UE, wherein:
the PDCCH configuration information associated with the first UE or the PDCCH configuration information associated with the second UE are configured by the BS;
detecting the UL transmission grant by the second UE comprises detecting the UL transmission grant by the second UE based on the received the PDCCH configuration information associated with the first UE or the PDCCH configuration information associated with the second UE; and
the UL transmission grant is scrambled by the C-RNTI associated with the first UE or the C-RNTI associated with the second UE.

16. (canceled)

17. The method of claim 13, further comprising:
receiving, by the second UE, the C-RNTI associated with the first UE from the first UE, wherein:
the C-RNTI associated with the first UE is notified by the first UE; and
detecting the UL transmission grant by the second UE comprises detecting the UL transmission grant by the second UE based on the C-RNTI associated with the first UE on a PDCCH recourse corresponding to the PDCCH configuration information associated with the second UE.

18. The method of claim 13, further comprising:
receiving, by the second UE, the PDCCH configuration information associated with the first UE from the first UE; and
receiving the C-RNTI associated with UE 1 from the BS, wherein:
the PDCCH configuration information associated with the first UE is notified by the first UE; and
detecting the UL transmission grant by the second UE comprises detecting the UL transmission grant based on the C-RNTI associated with UE 1 on a PDCCH recourse corresponding to the PDCCH configuration information associated with the first UE.

19. The method of claim 13, further comprising at least one of:
receiving, by the second UE from the first UE, the C-RNTI associated with the first UE and the PDCCH configuration information associated with the first UE, wherein the C-RNTI associated with the first UE and the PDCCH configuration information associated with the first UE are notified by the first UE;
receiving, by the second UE, the C-RNTI associated with the first UE and the PDCCH configuration information associated with the first UE from the BS, wherein the C-RNTI associated with the first UE and the PDCCH configuration information associated with the first UE are configured by the BS:
receiving, by the second UE, the C-RNTI associated with the first UE from the BS. wherein the C-RNTI associated with the first UE is configured by the BS. wherein detecting the UL transmission grant by the second UE comprises detecting the UL transmission grant according to the C-RNTI associated with the first UE on a PDCCH recourse corresponding to the PDCCH configuration information associated with the second UE; or
determining, according to a PDCCH resource used to deliver the UL transmission grant. whether the UL transmission grant detected based on the C-RNTI associated with the second UE is configured for transmission of data from the first UE or data originated from the second UE.

20-21. (canceled)

22. The method of claims 1, further comprising;
receiving, by the first UE or by the second UE from the BS or the first UE, a UL transmission grant indicating transmission configuration information configured for the second UE or configured based on an environment of the second UE.

23. (canceled)

24. The method of claims 1, wherein transmitting, by the second UE, the data to the BS comprises transmitting, by the second UE, the data at the same time with the first UE.

25. A wireless communication method, comprising:
receiving, by a base station (BS), first user equipment (UE)'s data transmitted by a second UE according to a transmission configuration.

26. (canceled)

27. The method of claim 25, further comprising at least one of:
transmitting transmission configuration information to the first UE or the second UE. the transmission configuration information includes at least one of: an uplink (UL) transmission grant, a resource information, beam information, layer number information, or power control information:
receiving, from the second UE, an SR PUCCH transmitted based on at least one of an SR sequence or an SR PUCCH resource based on the configuration information determined according to SR configuration information;
receiving, from the second UE, a CSI PUCCH transmitted based on at least one of a CSI reporting or a CSI PUCCH resource determined according to CSI PUCCH configuration information;
receiving, from the second UE, an SRS transmitted based on at least one of an SRS sequence or an SRS resource determined according to the SRS configuration information; or
receiving, from the second UE, the data transmitted based on a CG PUSCH resource determined according to CG PUSCH configuration information.

28. The method of claim 25, further comprising at least one of:
receiving an RRC signaling, by the BS, indicating that the first UE and the second UE are paired for aggregated transmission;
transmitting, by the BS to the first UE, a UL transmission grant indicating transmission configuration information, which includes two sets of transmission configurations, respectively configured for the first UE and the second UE; or
configuring two sets of PDCCH configuration information corresponding to two PDCCH resources for transmitting UL transmission grants respectively for UL data transmission of the first UE's data or the second UE's data.

29. (canceled)

30. The method of claim 25, further comprising:
transmitting, by the BS to the first UE or the second UE, at least one of: SR (scheduling request) configuration information of the first UE or the second UE, CSI PUCCH configuration information of the first UE or the second UE, SRS configuration information of the first UE or the second UE, or CG PUSCH configuration information of the first UE or the second UE,
wherein:
at least one of the SR configuration information of the first UE or the second UE, CSI PUCCH configuration information of the first UE or the second UE, SRS configuration information of the first UE or the second UE, or CG PUSCH configuration information of the first UE or the second UE includes a UE ID, which indicates whether the at least one configuration information is associated to the first UE or the second UE; or
the method further comprises at least one of.
receiving, from the second UE, an SR PUCCH based on at least one of an SR sequence or an SR PUCCH resource based on the SR configuration information determined according to SR configuration information:
receiving, from the second UE. a CSI PUCCH based on at least one of a CSI reporting or a CSI PUCCH resource determined according to CSI PUCCH configuration information;
determining, by the second UE, at least one of: an SRS sequence or an SRS resource based on the SRS configuration information:
receiving, from the second UE, an SRS based on at least one of an SRS sequence or an SRS resource determined according to the SRS configuration information; or
receiving, from the second UE, the data based on a CG PUSCH resource determined according to the CG PUSCH configuration.

31-32. (canceled)

33. The method of claim 25, further comprising:
transmitting, by the BS to the first UE or the second UE at least one of a C-RNTI associated with the first UE, a C-RNTI associated with the second UE, a PDCCH configuration information associated with the first UE, or a PDCCH configuration information associated with the second UE; and
transmitting, by the BS to the first UE or the second UE, a UL transmission grant on a resource corresponding to the PDCCH configuration information associated with the first UE or the second UE,
wherein the UL transmission grant indicates transmission configuration information configured for the second UE or configured based on an environment of the second UE.

34-36. (canceled)

37. A wireless communication apparatus, comprising a memory storing one or more programs and one or more processors electrically coupled to the memory and configured to execute the one or more programs to perform a methods, comprising:
obtaining, by second user equipment (UE), a transmission configuration corresponding to first user equipment for transmitting data from the first UE; and
transmitting, by the second UE, the data to a base station (BS) according to the transmission configuration.

38. A non-transitory computer-readable storage medium, storing one or more programs, the one or more programs being configured to. when executed by a processor. cause to perform the method of claims 1.
